(19) United States
(12) Patent Application Publication
(10) Pub. No.: US 2006/0204009 A1
(43) Pub. Date: Sep. 14, 2006

(54) Physical layer built-in security enhancement of spread spectrum wireless communication systems

(75) Inventors: Tongtong Li, Okemos, MI (US); Jian Ren, Okemos, MI (US); Qi Ling, E. Lansing, MI (US); Weiguo Liang, Mountain View, CA (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Michigan State University

(21) Appl. No.: 11/374,884

(22) Filed: Mar. 14, 2006

Related U.S. Application Data
(60) Provisional application No. 60/661,464, filed on Mar. 14, 2005.

(51) Int. Cl. H04K 1/00

(52) U.S. Cl. 380/255

(57) ABSTRACT

This disclosure contains three parts. First, it provides a quantitative analysis on the weaknesses of the physical layer built-in security of the operational and the proposed 3G spread spectrum based wireless communication systems. Second, it incorporates advanced cryptographic techniques into wireless transceiver design. More specifically, it proposes an AES based secure scrambling process to enhance the physical layer built-in security of spread spectrum systems, and therefore formulates a joint physical layer and network layer privacy protection scheme. Third, it provides an AES based secure interleaving process to ensure excellent system performance over channels experiencing severe fading and/or burst errors. The proposed schemes can be extended to general wireless systems in multiple ways.

### CROSS-REFERENCE TO RELATED APPLICATION

This application claims priority under 35 U.S.C. §119(e) on U.S. Provisional Patent Application No. 60/661,464 filed on Mar. 14, 2005, entitled “PHYSICAL LAYER BUILT-IN SECURITY ENHANCEMENT AND ANALYSIS OF CDMA SYSTEMS,” and filed on behalf of Tongtong Li et al. The entire disclosure of which is incorporated by reference herein.

### BACKGROUND OF THE INVENTION

The present invention generally relates to communication systems and methods, and more particularly relates to security enhancements for spread spectrum wireless communication systems.

With the rapid development of wireless techniques, people are relying more and more on wireless communication networks for critical information transmission, and wireless security has become an urgent issue and a bottleneck for new wireless communication services such as wireless mobile Internet and e-commerce [see, for example, R. K. Nichols and P. C. Lekkas, Wireless Security: Models, Threats, and Solutions, McGraw-Hill Telecom, 2002]. The security techniques that are based on the possession of wireless receivers are out-of-date and have to be improved by applying modern cryptographic technologies, such as pseudo-random sequences design, data encryption and access control.

Direct sequence spread spectrum systems, widely known as code division multiple access (CDMA) systems were historically developed for secure communication and military use. Due to its high spectral efficiency and simple system planning, CDMA is now serving as one of the most widely used wireless airlink interfaces, is used in the U.S. digital cellular standard IS-95, and has become one of the most attractive modulation techniques for the next generation wireless networks [see, for example, Theodore S. Rappaport, Wireless Communications—Principles and Practices, Prentice Hall, second edition, 2002 and J. G. Proakis, Digital Communications, McGraw-Hill, 4th edition, 2000].

In CDMA systems, each user is assigned a specific spreading sequence to modulate its message signal. The spreading process increases the bandwidth of the message signal by a factor N, known as spreading factor or the processing gain, and meanwhile reduces the power spectrum density of the signal also by a factor N. With large bandwidth and low power spectrum density, CDMA signals are resistant to malicious narrow band jamming and can easily be concealed within the noise floor thereby preventing an unauthorized person from detecting the CDMA signals. Moreover; the message signal can not be recovered unless the spreading sequence is known, making it difficult for an unauthorized person to intercept the signal. This is known as the built-in security feature of CDMA systems.

In the operational direct sequence CDMA (DS-CDMA) systems, as shown in FIG. 1, each user's signal uⱼ(k) is first spread using a spreading code 10 (hereinafter referred to as a channelization code) spanning over just one symbol or multiple symbols. The spread signal rⱼ(n) is then further scrambled using a pseudo-random sequence 15 to produce a signal sⱼ(n), to randomize the interference and to make it more difficult to intercept and detect the signal yⱼ⁽ⁱ⁾(n) transmitted through the channel 20.

Since the channelization codes are typically chosen to be Walsh codes, which are easy to generate, the physical layer built-in security of CDMA systems mainly relies on the long pseudo-random scrambling sequence 15, also known as long code. Relying upon the long pseudo-random spreading sequence generator 15, the existing operational CDMA system (as used in IS-95) and the 3rd Generation Partnership Project for Universal Mobile (3GPP UMTS) system can provide a near-satisfactory physical layer built-in security solution to voice centric wireless communications, since generally each voice conversation only lasts a very short period of time. However, the security features provided by these systems are far from adequate and acceptable when used for data communications. The security weakness of the existing IS-95 CDMA and the 3GPP UMTS airlink interface is described further below.

in IS-95, the long code generator consists of a 42-bit number called long code mask and a 42-bit linear feedback shift register (LFSR) specified by the following characteristic polynomial:

$${x}^{42} + {x}^{35} + {x}^{33} + {x}^{31} + {x}^{27} + {x}^{26} + {x}^{25} + {x}^{22} + {x}^{21} + {x}^{19} + {x}^{18} + {x}^{17} + {x}^{16} + {x}^{10} + {x}^{7} + {x}^{6} + {x}^{5} + {x}^{3} + {x}^{2} + x + 1 , \qquad ( 1 )$$

where the 42-bit long code mask is shared between the mobile and the base station. As shown in FIG. 2, each chip of the long code sequence is generated by the modulo-2 inner product of a 42-bit long code mask and the 42-bit state vector of the LFSR.

Letting M=[m₁, m₂, . . . , m₄₂] denote the 42-bit mask and S(t)=[s₁(t), s₂(t), . . . , s₄₂(t)] denote the state vector of the LFSR at time instance t. The long code sequence c(t) at time t can thus be represented as:
c(t)=m₁s₁(t)+m₂S₂(t)+ . . . +m₄₂s₄₂((t), (2)
where the additions are modulo-2 additions.

As is well known, for a sequence generated from an n-stage LFSR, if an eavesdropper can intercept a 2n-bit sequence segment, then the characteristic polynomial and the entire sequence can be reconstructed according to the Berlekamp-Massey algorithm [see, for example, James L. Massey, “Shift-Register Synthesis and BCH Decoding,” IEEE Trans. on Information Theory, 15:122-127, January 1969]. This leaves an impression that the maximum complexity to recover the long code sequence c(t) is O(2⁸⁴). However, for IS-95, since the characteristic polynomial is known to the public, an eavesdropper only needs to obtain 42 bits of the long code sequence to determine the entire sequence [see Muxiang Zhang, Christopher Carroll, and Agnes Hui Chan, “Analysis of IS-95 CDMA Voice Privacy,” in Selected Areas in Cryptography, pages 1-13, 2000]. That is, the maximum complexity to recover the long code sequence c(t) is only O(2⁴²).

In fact, since s₁(t), s₂(t), . . . , s₄₂(t) are the outputs of the same LFSR, they should all be the same except for a phase difference, i.e.,
s₄₂(t)=s₄₁(t−1)= . . . =s₁(t−41) (3)

Letting a=[a₁, a₂, . . . , a₄₂] denote of the coefficient vector of the characteristic polynomial in Equation (1), then it follows from equation (3) that:

$$\begin{matrix}{s}_{i} ( t ) = {a}_{1} {s}_{i - 1} ( t ) + {a}_{2} {s}_{i - 2} ( t ) + … + {a}_{42} {s}_{i - 42} ( t ) \\ = {a}_{1} {s}_{i} ( t - 1 ) + {a}_{2} {s}_{i} ( t - 2 ) + … + {a}_{42} {s}_{i} ( t - 42 )\end{matrix} \qquad ( 4 )$$

Substituting equation (4) into equation (2), provides

$$\begin{matrix}c ( t ) = {\sum }_{i = 1}^{42} {m}_{i} {s}_{i} ( t ) \\ = {\sum }_{i = 1}^{42} {m}_{i} ( {\sum }_{j = 1}^{42} {a}_{j} {s}_{i} ( t - j ) ) \\ = {\sum }_{j = 1}^{42} {m}_{i} ( {\sum }_{i = 1}^{42} {m}_{i} {s}_{i} ( t - j ) ) \\ = {\sum }_{j = 1}^{42} {a}_{j} c ( t - j )\end{matrix} \qquad ( 5 )$$

Defining

$$A = [ \begin{matrix}{a}_{1} & 1 & 0 & ⋯ & 0 \\ {a}_{2} & 0 & 1 & ⋯ & 0 \\ ⋮ & ⋮ & ⋮ & ⋰ & ⋮ \\ {a}_{41} & 0 & 0 & ⋯ & 1 \\ {a}_{42} & 0 & 0 & ⋯ & 0\end{matrix} ] , \qquad ( 6 )$$

then it allows
[c(t),c(t−1), . . . , c(t−41)]=[c(t−1), c(t−2), . . . , c(t−42)]* A. (7)
Letting ((t)=[c(t),c(t−1), . . . , c(t−41)], then for any n≧t, from equation (7),
C(n)=C(t)*A^{n-t}. (8)

Therefore, as long as as C(t) for a time instance t is known, then the entire sequence can be recovered. In other words, as long as an eavesdropper can intercept/recover up to 42 continuous long code sequence bits, then the whole long code sequence can be regenerated.

For the 3GPP UMTS system, the maximum complexity to recover the scrambling code based on ciphertext only attack is O(2³⁶), which implies that the physical layer built-in security of the 3GPP UMTS is actually weaker than that of the IS-95 system. Therefore, the long code sequence is vulnerable under ciphertext-only attacks.

Once the long code sequence is recovered, then the desired user's signal can be recovered through signal separation and extraction techniques. If the training sequence is known, simple receivers, for example, a Rake receiver, can be used to extract the desired user's signal. Even if the training sequence is unknown, a desired user's signal can still be recovered through blind multi-user detection and signal separation algorithms, such as disclosed in: (1) S. Bhashyam and B. Aazhang, “Multiuser Channel Estimation and Tracking for Long-Code CDMA Systems,” IEEE Trans. on Communications, 50(7):1081-1090, July 2002; (2) C. J. Escudero, U. Mitra, and D. T. M. Slock, “A Toeplitz Displacement Method for Blind Multipath Estimation for Long Code DS/CDMA Signals,” IEEE Trans. on Signal Processing, 49(3):654-665, March 2001; (3) Lang Tong, van der Veen A., P. Dewilde, and Youngchul Sung, “Blind Decorrelating RAKE Receivers for Long-Code WCDMA,” IEEE Trans. on Signal Processing, 51(6):1642 -1655, June 2003; and (4) A. J. Weiss and B. Friedlander, “Channel Estimation for DS-CDMS Downlink with Aperiodic Spreading Codes,” IEEE Trans. on Communications, 47(10): 1561-1569, October 1999.

Accordingly, there is a need for security enhancements to conventional CDMA systems. However, merely applying additional security measures may result in significant computational complexity and a significant lessening of system performance based primarily on the computations required to add such enhanced security.

### SUMMARY OF THE INVENTION

According to one aspect of the present invention, a transmitter is provided for use in a spread spectrum communication system. The transmitter comprises a spreading block, a secure scrambler, and a transmitter circuit. The spreading block receives a user's plaintext message and spreads the plaintext message to generate a chip-level signal. The secure scrambler scrambles and encrypts the chip-level signal using a long code sequence generated by the advanced encryption standard algorithm. The transmitter circuit transmits the securely scrambled chip-level signal.

According to another aspect of the present invention, a receiver is provided for use in a spread spectrum communication system. The receiver comprises a receiver circuit, a secure descrambler, and a dispreading block. The receiver circuit receives a securely scrambled chip-level signal. The secure descrambler descrambles the securely scrambled chip-level signal using a key generated by an advanced encryption standard algorithm. The despreading block receives the decrypted chip-level signal and despreads the chip-level signal to generate a sender's original plaintext message.

According to another aspect of the present invention, a method is provided for enhancing the built-in security of a spread spectrum communication system. The method comprises the steps of: receiving an originator's plaintext message and spreading the plaintext message to generate a chip-level signal; securely scrambling the chip-level signal using a long code sequence generated by the advanced encryption standard algorithm; and transmitting the securely scrambled chip-level signal.

According to another aspect of the present invention, a transmitter is provided for use in a spread spectrum communication system. The transmitter comprises a spreading block, an interleaver, and a transmitter circuit. The spreading block receives a user's symbol-level plaintext message signal and spreads the plaintext message signal to generate a chip-level signal. The interleaver operator interleaves segments of the chip-level signal through a block interleaver. The transmitter circuit efficiently transmits the interleaved segments of the chip-level signal.

According to another aspect of the present invention, a receiver is provided for use in a spread spectrum communication system. The receiver comprises a receiver circuit, a deinterleaver, and a despreading block. The receiver circuit for receives a signal including interleaved segments of a chip-level signal. The deinterleaver operator deinterleaves the interleaved segments of the chip-level signal using a block interleaver to output a chip-level signal. The despreading block for receives the chip-level signal and despreads the chip-level signal to generate a sender's original plaintext message signal.

According to another aspect of the present invention, a method is provided for enhancing security of a spread spectrum communication system. The method comprises the steps of: receiving an originator's symbol-level plaintext message signal and spreading the plaintext message signal to generate a chip-level signal; interleaving segments of the chip-level signal through a secure block interleaver; and transmitting the interleaved segments of the chip-level signal.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a block diagram of a conventional long code DS-CDMA system;

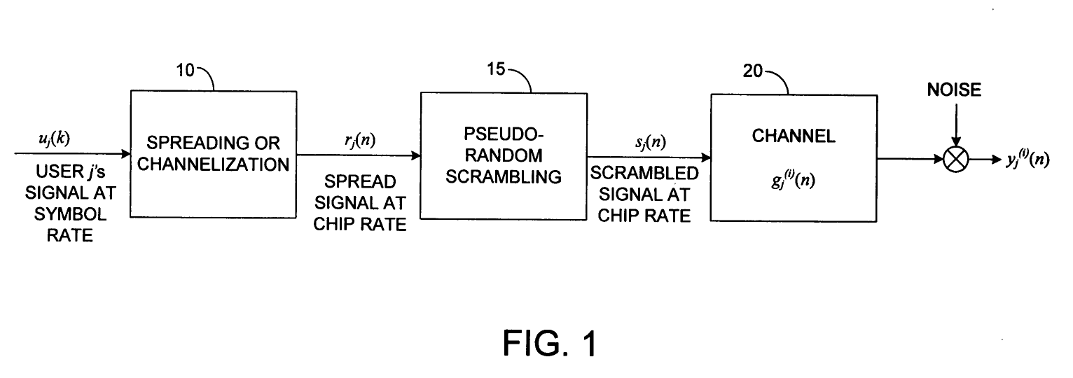

FIG. 2 is a block diagram of a conventional IS-95 long code generator;

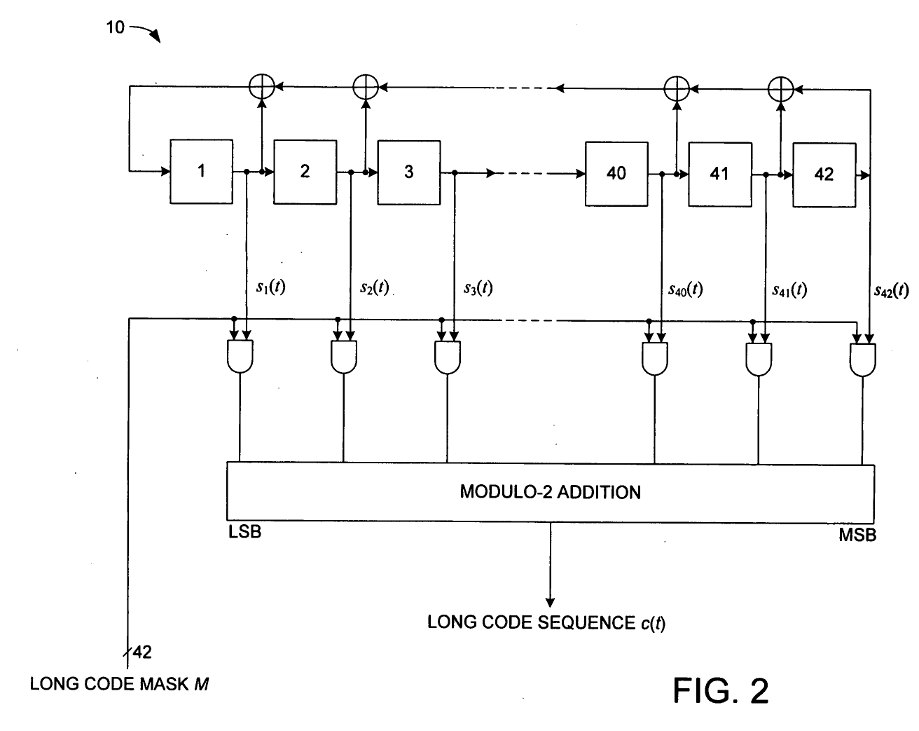

FIG. 3 is a block diagram illustrating CDMA physical layer secure scrambling according to a first embodiment of the present invention;

FIG. 4 is a graph including four plots of the bit-error-rate (BER) versus different signal-to-noise ratio (SNR) levels, assuming 4 equal power users in the system and a processing gain of N=16, where the four plots illustrate the comparison of system performance over channels with severe fading for four scenarios: conventional scrambling with conventional training, secure scrambling with conventional training, conventional scrambling with separated training, secure scrambling with separated training.

FIG. 5 is a block diagram illustrating a DS-CDMA system with chip-level interleaving according to a second embodiment of the present invention;

FIG. 6 is a graph including four plots of the BER versus different signal-to-noise ratio (SNR) levels, assuming 8 equal power users in the system and a processing gain of N=16, where the four plots illustrate the comparison of system performance over channels with severe fading for four scenarios: conventional scrambling, secure scrambling, pseudo-random interleaving and secure block interleaving;

FIG. 7 is a graph including four plots of the BER versus system load (i.e., number of users), assuming a SNR of 20 dB, where the four plots illustrate the comparison of system performance over channels with severe fading for four scenarios: conventional scrambling, secure scrambling, pseudo-random interleaving and secure block interleaving;

FIG. 8 is a graph including four plots of the BER versus different signal-to-noise ratio (SNR) levels, assuming 8 equal power users in the system and a processing gain of N=16, where the four plots illustrate the comparison of system performance over channels with strong burst noise for four scenarios: conventional scrambling, secure scrambling, pseudo-random interleaving and secure block interleaving; and

FIG. 9 is a graph including four plots of the BER versus system load (i.e., number of users), assuming a SNR of 20 dB, where the four plots illustrate the comparison of system performance over channels with strong burst noise for four scenarios: conventional scrambling, secure scrambling, pseudo-random interleaving and secure block interleaving.

### DETAILED DESCRIPTION OF THE PREFERRED EMBODIMENTS

In this invention, we propose to enhance the physical layer built-in security of spread spectrum systems, such as CDMA systems, by integrating advanced cryptographic techniques into the transmitter-receiver (transceiver) design and exploiting the inherent ambiguity in signal detection over multiple access wireless channels.

As described further below, a spread spectrum communication system may comprise at least one receiver and at least one transmitter. The transmitter(s) may comprise a spreading block, a transmitter circuit, and either or both of a secure scrambler and an interleaver operator. The spreading block receives an originator's symbol-level plaintext message signal and spreads the plaintext message signal to generate a chip-level signal. The secure scrambler scrambles the chip-level signal using a pseudo-random long code sequence that may be generated using an AES algorithm. The interleaver operator interleaves segments of the chip-level signal through a block interleaver. The transmitter circuit efficiently transmits the interleaved segments of the chip-level signal.

The receiver(s) comprise a receiver circuit, a despreading block, and either or both of a deinterleaver operator and a descrambler. The receiver circuit receives a transmitter output and recovers the interleaved segments of the chip-level signal. The deinterleaver operator deinterleaves the interleaved segments of the chip-level signal through the block interleaver to recover the chip-level signal. The descrambler descrambles the scrambled chip-level signal to regenerate the chip-level signal. The despreading block for receives the chip-level signal and despreads the chip-level signal sequence to generate the originator's plaintext message signal.

From the analysis of the weaknesses of the existing operational IS-95 and proposed 3GPP CDMA systems, the existing physical layer built-in security solution in these systems is far from adequate and acceptable for today's multimedia wireless communication systems.

Based on the observation that the physical layer built-in security of CDMA systems mainly relies on the pseudo-random scrambling process, the inventors propose to enhance the physical layer built-in security by introducing the concept of secure scrambling. More specifically, instead of scrambling the chip-level signal using the current long code sequence directly as in the IS-95 and CDMA systems, the inventors propose to encrypt the long code sequence by exploiting the advanced encryption standard (AES), and then scramble the chip-level signal with the encrypted long code sequence. The transmitter and the receiver share the common initial state of the long code sequence generator and the common secret encryption key. This makes it extremely difficult for the malicious user to recover the desired user's scrambling sequence, and hence provide strong information confidentiality to every protected user.

Furthermore, the inventors propose the concept of secure block interleaving motivated by the observation that after spreading and scrambling, chips spread from one symbol still cluster together, and could be fragile to several channel fading effects or burst errors. Since interleaving can randomize the successive information so that when there is a deep fade or burst noise, the successive data is not corrupted at the same time, secure interleaving may replace or supplement the above-described secure scrambling. Therefore the system reliability in the unpredictable wireless environment can be increased while enhancing the physical layer built-in security. More specifically, the inventors propose to generate secure row and column secure interleaving index by exploiting the AES algorithm. The inventors' simulation results demonstrated that while achieving strong information confidentiality as secure scrambling, significant improvement in transmission reliability can be observed when secure interleaving is exploited.

The idea to enhance the physical layer built-in security by incorporating advanced cryptographic techniques into pseudo-random sequence generation can be generalized directly to frequency hopping (FH) spread spectrum systems, for which AES may be exploited to encrypt the pseudo-random sequence that controls the hopping frequencies in the FH system.

Furthermore, both secure scrambling and secure interleaving can be extended to general wireless systems other than only spread spectrum systems, either by direct application or being incorporated into forward error control to achieve secure channel coding.

The physical layer built-in security feature can either be used independently or in conjunction with the upper layer privacy protection processes to meet different security requirement. When combined with upper layer privacy protection approaches, a multi-layer privacy protection mechanism can be formulated for extremely strong information confidentiality.

While providing significantly enhanced information confidentiality, the proposed approaches ensure a smooth and cost-effective upgrade process for the existing communication systems by minimizing the mandatory changes in hardware, and will have a strong and direct impact on the communication industry.

Two embodiments are described below. The first embodiment involves the provision of secure scrambling of the chip-level signal using an encryption algorithm, such as the advanced encryption standard (AES) algorithm. The second embodiment utilizes secure interleaving of the chip-level signal, which improves the performance of the system in environments with severe fading and strong burst errors.

### I. The First Embodiment

### Security Enhancement of the Scrambling Process Based on AES

As can be seen from the above discussion, the physical layer security of CDMA systems relies on the scrambling process, and the built-in information confidentiality provided by the operational IS-95 and proposed 3GPP UMTS systems is far from adequate. According to a first embodiment of the present invention, an encrypted key stream based on advanced encryption standard (AES) is proposed to be used in the scrambling process, instead of using the scrambling sequence generated from the 42-bit long code mask and the 42-bit linear feedback shift register (LFSR) as in IS-95. Ensured by AES, also known as Rijndael, the physical layer built-in security of the proposed scheme is significantly improved compared to that of the IS-95 system. The proposed scheme can readily be applied to next generation (i.e., third generation (3G) systems) and IEEE 802.11 WLAN systems, in combination with MAC layer and network layer security protocols, wireless network security can thus be ensured from both the physical layer and upper layers.

Rijndael was identified as the new AES in October 2, 2000. Rijndael's combination of security, performance, efficiency, ease of implementation and flexibility makes it an appropriate selection for the AES. Rijndael is a good performer in both hardware and software across a wide range of computing environments. Its low memory requirements make it very well suited for restricted-space environments such as mobile handsets to achieve excellent performance. A brief introduction of AES is provided below. Additional details of AES are disclosed in “AES Proposal: Rijndael” by Joan Daemen and Vincent Rijmen, March 1999 (hereinafter referred to as “the AES Proposal document”), the entire disclosure of which is incorporated herein by reference.

Although AES is a new Federal Information Processing Standard (FIPS) for data encryption, it had been designed for use by U.S. Government organizations to protect sensitive (unclassified) information. AES is being developed to replace Data Encryption Standard (DES), but NIST anticipates that Triple DES will remain an approved algorithm (for U.S. Government use) for the foreseeable future. Thus, AES had not previously been discussed or proposed for use in enhancing the physical layer built-in security of CDMA systems.

### II. Secure Scrambling Based on the AES Algorithm

AES is a secret key block cipher. Namely, it breaks the plaintext into blocks and encrypts each block separately. Three different block sizes are supported in AES: 128 bits, 192 bits and 256 bits with three allowable encryption key sizes: 128 bits, 192 bits and 256 bits. Here, for simplicity, the block size and key size will both hereinafter be described as 128 bits. Although a greater number of bits may be used.

Let M denote the 128 bits plaintext sequence to be encrypted. At the beginning of the cipher, M is divided into 16 continuous bytes
M=[m₀, m₁, . . . , m₁₅] (9)
These 16 bytes are then arranged into a 4×4 matrix and is copied to a 4×4 array aᵢⱼ, ij=0, 1, 2, 3, called the State Array, as follows:

$$A = [ \begin{matrix}{a}_{0 , 0} & {a}_{0 , 1} & {a}_{0 , 2} & {a}_{0 , 3} \\ {a}_{1 , 0} & {a}_{1 , 1} & {a}_{1 , 2} & {a}_{1 , 3} \\ {a}_{2 , 0} & {a}_{2 , 1} & {a}_{2 , 2} & {a}_{2 , 3} \\ {a}_{3 , 0} & {a}_{3 , 1} & {a}_{3 , 2} & {a}_{3 , 3}\end{matrix} ] {=}^{Δ} [ \begin{matrix}{m}_{0} & {m}_{4} & {m}_{8} & {m}_{12} \\ {m}_{1} & {m}_{2} & {m}_{9} & {m}_{13} \\ {m}_{2} & {m}_{6} & {m}_{10} & {m}_{14} \\ {m}_{3} & {m}_{7} & {m}_{11} & {m}_{15}\end{matrix} ] \qquad ( 10 )$$

In AES cipher, the following four basic steps (also called layers), the ByteSub Transformation, the ShiftRow transformation, the MixColumn transformation and the AddRoundKey transformation are defined to form a round. To ensure strong security while minimizing the implementation complexity, ciphers are generated by repeating the same process module (called a round) multiple times. For AES with block size and key size equal to 128 bits, the number of rounds Nᵣ is chosen to be 10 in the standard.

1) ByteSub Transformation. This layer operates on each byte of the State Array matrix independently using a substitution table, called an S-box. To do this, each entry in the State Array matrix is divided into two 4-bit groups and written as two hexadecimal numbers X, Y and aᵢⱼ is then substituted by the entry of the S-box at row X and column Y. The output of the ByteSub is again a 4×4 matrix of bytes, denoted as

$$B = [ \begin{matrix}{b}_{0 , 0} & {b}_{0 , 1} & {b}_{0 , 2} & {b}_{0 , 3} \\ {b}_{1 , 0} & {b}_{1 , 1} & {b}_{1 , 2} & {b}_{1 , 3} \\ {b}_{2 , 0} & {b}_{2 , 1} & {b}_{2 , 2} & {b}_{2 , 3} \\ {b}_{3 , 0} & {b}_{3 , 1} & {b}_{3 , 2} & {b}_{3 , 3}\end{matrix} ] \qquad ( 11 )$$

2) ShiftRow Transformation. In the ShiftRow transformation, the bytes in the last three rows of the State Array matrix B are cyclically shifted left by 1, 2, and 3 positions respectively to obtain

$$C = [ \begin{matrix}{c}_{0 , 0} & {c}_{0 , 1} & {c}_{0 , 2} & {c}_{0 , 3} \\ {c}_{1 , 0} & {c}_{1 , 1} & {c}_{1 , 2} & {c}_{1 , 3} \\ {c}_{2 , 0} & {c}_{2 , 1} & {c}_{2 , 2} & {c}_{2 , 3} \\ {c}_{3 , 0} & {c}_{3 , 1} & {c}_{3 , 2} & {c}_{3 , 3}\end{matrix} ] {=}^{Δ} [ \begin{matrix}{b}_{0 , 0} & {b}_{0 , 1} & {b}_{0 , 2} & {b}_{0 , 3} \\ {b}_{1 , 1} & {b}_{1 , 2} & {b}_{1 , 3} & {b}_{1 , 0} \\ {b}_{2 , 2} & {b}_{2 , 3} & {b}_{2 , 0} & {b}_{2 , 1} \\ {b}_{3 , 3} & {b}_{3 , 0} & {b}_{3 , 1} & {b}_{3 , 2}\end{matrix} ] \qquad ( 12 )$$

3) MixColumn Transformation. At this step, regarding each bytes cᵢⱼ in C as an element of GF(2⁸) and multiply the 4×4 matrix C by a matrix with entries in GF(2⁸), represented in hexadecimal, to produce

$$\begin{matrix}D = [ \begin{matrix}{d}_{0 , 0} & {d}_{0 , 1} & {d}_{0 , 2} & {d}_{0 , 3} \\ {d}_{1 , 0} & {d}_{1 , 1} & {d}_{1 , 2} & {d}_{1 , 3} \\ {d}_{2 , 0} & {d}_{2 , 1} & {d}_{2 , 2} & {d}_{2 , 3} \\ {d}_{3 , 0} & {d}_{3 , 1} & {d}_{3 , 2} & {d}_{3 , 3}\end{matrix} ] \\ {=}^{Δ} [ \begin{matrix}02 & 03 & 01 & 01 \\ 01 & 02 & 03 & 01 \\ 01 & 01 & 02 & 03 \\ 03 & 01 & 01 & 02\end{matrix} ] [ \begin{matrix}{c}_{0 , 0} & {c}_{0 , 1} & {c}_{0 , 2} & {c}_{0 , 3} \\ {c}_{1 , 0} & {c}_{1 , 1} & {c}_{1 , 2} & {c}_{1 , 3} \\ {c}_{2 , 0} & {c}_{2 , 1} & {c}_{2 , 2} & {c}_{2 , 3} \\ {c}_{3 , 0} & {c}_{3 , 1} & {c}_{3 , 2} & {c}_{3 , 3}\end{matrix} ]\end{matrix} \qquad ( 13 )$$

4) AddRoundKey Transformation. In this step, a round key matrix, derived from the encryption key (please refer to the AES Proposal document for AES Key Schedule description ), is added to the State Array D by a simple bitwise XOR operation.

$$\begin{matrix}E = [ \begin{matrix}{e}_{0 , 0} & {e}_{0 , 1} & {e}_{0 , 2} & {e}_{0 , 3} \\ {e}_{1 , 0} & {e}_{1 , 1} & {e}_{1 , 2} & {e}_{1 , 3} \\ {e}_{2 , 0} & {e}_{2 , 1} & {e}_{2 , 2} & {e}_{2 , 3} \\ {e}_{3 , 0} & {e}_{3 , 1} & {e}_{3 , 2} & {e}_{3 , 3}\end{matrix} ] \\ {=}^{Δ} [ \begin{matrix}{d}_{0 , 0} & {d}_{0 , 1} & {d}_{0 , 2} & {d}_{0 , 3} \\ {d}_{1 , 0} & {d}_{1 , 1} & {d}_{1 , 2} & {d}_{1 , 3} \\ {d}_{2 , 0} & {d}_{2 , 1} & {d}_{2 , 2} & {d}_{2 , 3} \\ {d}_{3 , 0} & {d}_{3 , 1} & {d}_{3 , 2} & {d}_{3 , 3}\end{matrix} ] \\ [ \begin{matrix}{k}_{0 , 0} & {k}_{0 , 1} & {k}_{0 , 2} & {k}_{0 , 3} \\ {k}_{1 , 0} & {k}_{1 , 1} & {k}_{1 , 2} & {k}_{1 , 3} \\ {k}_{2 , 0} & {k}_{2 , 1} & {k}_{2 , 2} & {k}_{2 , 3} \\ {k}_{3 , 0} & {k}_{3 , 1} & {k}_{3 , 2} & {k}_{3 , 3}\end{matrix} ]\end{matrix} \qquad ( 14 )$$

This is the final output of the round.

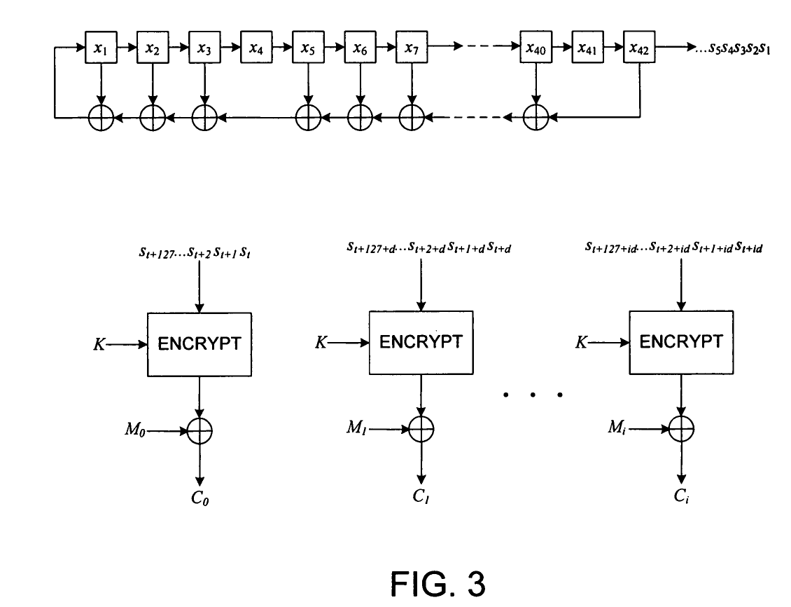

The proposed secure scrambling scheme of the first embodiment aims to increase the physical layer built-in security of CDMA systems, prevent exhaustive key search attack, while minimizing the changes required to the IS-95 and UMTS standards. As shown in FIG. 3, the proposed secure scrambling is essentially a counter mode AES. In FIG. 3, s₀S₁S₂ . . . represents the output of the LFSR characterized by equation (1) as in the IS-95 system, K is the 128 bits common secret encryption key shared between the base station and the mobile station (K can also be 192 bits or 256 bits, as specified in the AES algorithm), M₀, M₁, . . . , M₁ denote successive message blocks with the same size as K, and d is the shift between the successive inputs to the AES engine. If the input to the i-th encryption block is s_{t+id′}, s_{i+1+id′}. . . , s_{t+127+id} with initial delay t, then the input to the i+1-th block is s_{t+(i+1)d′}, s_{t+1+(i+1)d′}, s_{t+127+(i+l)d}. The selection of d should maximize the diversity between different inputs to the AES engine, which can be achieved by requiring d and 2⁴²−1 be relatively prime. In other words, d should not be divisible by 3, 7, 43 and 127.

The secure scrambling process can be summarized as:
1) The base station and the mobile station share a common initial state for the LFSR and an L-bit (L=128, 192 or 256) common secret encryption key K;
2) The long scrambling sequence is generated through encryption of a particular segment of the sequence generated from the LFSR using the shared secret key K; and
3) The scrambling process is realized by adding the scrambling sequence to the spread chip-level signal.

As described in V. K. Gray, IS-95 CDMA and cdma2000, Prentice Hall, 2000 and in TIA/EIA/IS-95-B, “Mobile Station-Base Station Compatibility Standard for Dual-Mode Wideband Spread Spectrum Cellular System,” 1998, the shared secret data between the mobile station and base station can be updated from time to time. To prevent malicious key reload, the key update request can only be initiated from the base station.

### III. Security of the Proposed Scrambling Process

In this section, Data Encryption Standard (DES) (see National Bureau of Standards, “DES modes of operation,” Technical Report FIPS Publication 81, National Bureau of Standards, 1980) is used as a benchmark to evaluate the security of the proposed secure scrambling, which is essentially ensured by AES. The number of possible keys of AES is compared to that of the IS-95 scrambling sequence. The number of keys determines the effort required to crack the cryptosystem by trying all possible keys.

The most important reason for DES to be replaced by AES is that it is becoming possible to crack DES by exhaustive key search. Single DES uses a 56-bit encryption key, which means there are approximately 7.2×10¹⁶ possible DES keys. In the late 1990s, specialized “DES Cracker” machines were built and could recover a DES key after a few hours. In other words, by trying all possible key values, the hardware could determine which key was used to encrypt a message [see EFF DES Cracker Project, Cracking DES, http://www.eff.org/descracker/]. Compared with DES, IS-95 has only 42-bit shared secret key. The approximate number of keys is about 4.40×10¹², which is less than 10⁴ of the number of DES 56-bit keys. This makes it possible to break the IS-95 long code sequence almost in real time through exhaustive key search.

On the other hand, AES specifies three key sizes: 128, 192 and 256 bits. In decimal terms, this means that approximately there are:
3.4×10³⁸ possible 128-bit keys;
6.2×10⁵⁷ possible 192-bit keys; and
1.1×10⁷⁷ possible 256-bit keys.

Thus, if we choose L=128, then there are on the order of 10²¹ times more AES 128-bit keys than DES 56-bit keys. Assuming that one could build a machine that could recover a DES key in a second (i.e., try 2⁵⁵ keys per second), as we can see, this is a very ambitious assumption and far from what we can do today, then it would take that machine approximately 149 thousand-billion (149 trillion) years to crack a 128-bit AES key. To put that into perspective, the universe is believed to be less than 20 billion years old.

Security measurement through the number of all possible keys is based on the assumption that the attacker has no easy access to the secret encryption key, therefore, the attacker has to perform an exhaustive key search in order to break the system. As is well known, the security of AES is based on the infeasible complexity in recovering the encryption key. Currently, no weakness has been detected for AES, thus, exhaustive key search is still being recognized as the most effective method in recovering the encryption key and breaking the cryptosystem. In the case of the present invention, in order for the attacker to obtain the scrambling sequence, the attacker needs to know both the input sequence and encryption key. It is reasonable to require that the 42-bit initial secret key of the LFSR in FIG. 3 be kept secret together with the 128-bit encryption key. And the attacker will only have access to the scrambled message sequence, for which the secure scrambling sequence is generated from encryption of a 128-bit segment of the LFSR sequence using 128-bit shared secret key between the mobile station and the base station.

As pointed out in the Background of the Invention, for the IS-95 system, the entire scrambling sequence can be regenerated as long as 42 successive bits of the scrambling sequence are recovered. In the proposed procedure, even if one block of the scrambling sequence is intercepted, the attacker still needs to recover the secret key K and the input segments [s_{1+id} . . . s_{i+127+id}] in order to regenerate the entire scrambling sequence, that is, the attacker still needs to break AES.

The key update technique currently used can reduce the risk for the opponent to maliciously reload a new key since the process is controlled by the base station. However, it is still essential to protect the encryption key and to protect the mobile station from being hacked by the malicious attackers.

### IV. Performance of CDMA System with Secure Scrambling

Pseudo-random scrambling in CDMA systems provides physical layer built-in user privacy for information transmission. However, from a communication point of view, scrambling was originally designed to reduce interference of mobiles that use the same channelization code in different cells, and to ensure performance stability among user population by providing the desired wide-band spectral characteristics, since the Walsh functions may not spread each symbol's power spectrum uniformly in the available frequency band [see S. Parkvall, “Variability of User Performance in Cellular DS-CDMA-Long versus Short Spreading Sequences,” IEEE Trans. on Communications, 48(7):1178-1187, July 2000 and Theodore S. Rappaport, Wireless Communications—Principles and Practices, Prentice Hall, second edition, 2002]. When applying secure scrambling, two natural questions are:
1) What effect does it have on system performance?
2) Will it introduce significant computational complexity?

In this section, it will be demonstrated that while providing strong physical layer built-in security, secure scrambling has comparable computational complexity and system performance with that of the conventional scrambling process.

First, we compare the computational complexity of the proposed secure scrambling and conventional scrambling. For this purpose, we only need to compare the complexity of the two scrambling sequence generation methods. Note that they both use the same 42-bit LFSR as specified in equation (1) above. In IS-95, each bit of the long scrambling code is generated through
c(t)=m₁s₁(t)+m₂s₂(t)+ . . . +m₄₂s₄₂(t). (15)

For the proposed secure scrambling, every 128-bit block of the scrambling sequence is generated through one AES encryption process. Using a Dell computer with 1024M RAM and 2.8 GHz CPU speed, the processing time required for every 128 bits was determined with the results provided in Table I. As can be seen, the computational complexity of secure scrambling is comparable with that of the scrambling process used in IS-95.

TABLE I
COMPLEXITY COMPARISON OF THE TWO GENERATION
METHODS OF LONG SCRAMBLING SEQUENCES

| Method | Time required for every 128 bits |
|---|---|
| IS-95 | 0.0226 second |
| Secure scrambling | 0.0536 second |

Next, under the same spectral efficiency, the input-output BER (bit-error-rate) performance of CDMA systems is compared for conventional scrambling and secure scrambling, respectively. In practical systems, after spreading and scrambling, passband PAM (pulse amplitude modulation) is performed. Mapping information bearing bits to symbols, passband PAM is equivalent to a complex-valued baseband PAM system [see J. G. Proakis, Digital Communications, McGraw-Hill, 4th edition, 2000]. When BPSK or QPSK is chosen, the modulo-2 addition between the message bits and the spreading sequence or the scrambling sequence is now equivalent to multiplying the message symbols using binary (±1) sequences. The description of this first embodiment is based on the equivalent discrete-time baseband PAM model of CDMA systems, for which the spreading sequences and scrambling sequences are both binary antipodal sequences.

Consider a DS-CDMA system with M users and K receiving antennas. Assuming the processing gain is N, that is, there are N chips per symbol. Let uⱼ(k) (j=1, . . . , M) denote User j's kth symbol of the user's symbol-level plaintext message signal. Without loss of generality, let
cⱼ=[cⱼ(0), cⱼ(1), . . . , cⱼ(N−1)] (16)
denote User j's channelization code or spreading code. The spread chip-level signal can be expressed as

$${r}_{j} ( n ) = {\sum }_{k = - ∞}^{∞} {u}_{j} ( k ) {c}_{j} ( n - kN ) . \qquad ( 17 )$$

The successive scrambling process is achieved by
s(n)=rⱼ(n)dⱼ(n), (18)
where dⱼ(n) is the chip-level scrambling sequence of user j.

Let {gⱼ⁽ⁱ⁾(l)}ₗ₌₀^{l-1} denote the (chip-level) channel impulse response from jth user to ith antenna, the received chip-rate signal at the ith antenna (i=1, 2, . . . , K) can be expressed as

$${y}_{i} ( n ) = {\sum }_{j = 1}^{M} {\sum }_{t = 0}^{L - 1} {g}_{j}^{( i )} ( l ) {s}_{j} ( n - 1 ) + {w}_{i} ( n ) . \qquad ( 19 )$$

where wᵢ(n) is the additive noise.

Based on equation (19), desired user's signal can be extracted through a two-stage procedure. First, training based channel estimation is performed through correlation. Secondly, a Rake receiver is applied to combine multipath components. It should be pointed out that currently, it is a common practice in industry to choose the chip rate training sequence to be all 1's. The training sequence is put as a prefix to the chip rate message sequence, and then scrambled using the long scrambling sequence. Channel estimation is therefore carried out based on the correlation property of the front part of the scrambling sequence. This practice has two drawbacks. First, from a security point of view, the front part of the scrambling sequence is exposed to attackers, which makes it possible to recover the whole scrambling sequence right away if secure scrambling is not used. This, at the meantime, illustrates the importance of secure scrambling, which can prevent the whole scrambling sequence being recovered based on the knowledge of part of it. Secondly, from the performance point of view, the correlation property of part of the scrambling sequence may not be ideal, and it can decrease the system performance due to non-accurate channel estimation.

To overcome these shortcomings, the system of the present invention may scramble the training sequence with an independent short scrambling sequence. The training sequence and its scrambling sequence are designed subject to the following constraints:
1) The short scrambling sequence is independent of the long scrambling sequence.
2) The short scrambling sequence has the same length as that of the training sequence.
3) The scrambled training sequence is a Gold sequence.

Or equivalently, we can choose the training sequence be a Gold sequence and then no scrambling is necessary for it. In the meantime, the information sequence is scrambled with the long scrambling sequence. In other words, the training sequence is separated from the information sequence in the scrambling procedure. As a result, the long scrambling sequence will not be exposed to malicious attackers and the channel estimation can be performed based on the low cross-correlation of Gold sequences. We term the proposed approach as “separated training”, and denote the conventional practice by “non-separated training”.

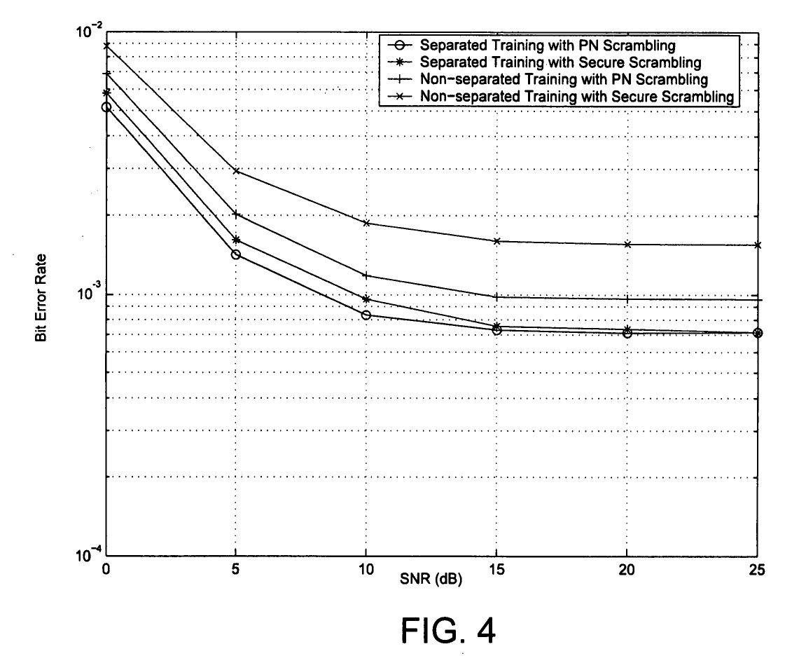

In the simulation, the processing gain was chosen to be N=16, and a single receiver case was considered. It was assumed that QPSK signals are transmitted over four-ray multipath channels for each user, with the first path be the dominant path. The multipath delays are uniformly distributed over the interval [0,N−1]. That is, the maximum multipath delay L is allowed to be up to one symbol period, a reasonable assumption for wideband CDMA systems. The short scrambling sequence is chosen to be Gold sequences of length 63, and training sequence is chosen to be a sequence of all 1's of the same length. Without loss of generality, User 1 is chosen to be the desired user. FIG. 4 shows the bit-error-rate (BER) versus different signal-to-noise ratio (SNR) levels, assuming four equal power users in the system. SNR is defined as the chip SNR with respect to User 1. Multipath channels and information sequence consisting of 1024 QPSK symbols were generated randomly in each Monte Carlo run. The result was averaged over 100 runs.

As can be seen, the inventive system with secure scrambling has comparable performance with that of IS-95, and “separated training” delivers much better results compared to that of “non-separated training”.

By generating the scrambling sequence through AES operations instead of using the long code sequence generated by a 42-bit mask and a 42-bit LFSR as in IS-95, the physical layer built-in security of the CDMA system is significantly increased with very limited complexity load. Moreover, it has been shown that by scrambling the training sequence and the message sequence separately with two independent scrambling sequences, both information privacy and system performance can be improved. These results can be extended to the physical layer built-in security enhancement of 3GPP UMTS systems in a direct manner.

### V. The Second Embodiment

### Secure Interleaving

In the discussion above and in Muxiang Zhang, Christopher Carroll, and Agnes Hui Chan, “Analysis of IS-95 CDMA Voice Privacy,” in Selected Areas in Cryptography, pages 1-13, 2000, the physical layer security weakness of the operational IS-95 CDMA airlink interface was analyzed [see also V. K. Gray, IS-95 CDMA and cdma2000, Prentice Hall, 2000]. It was pointed out that as long as up to 42 successive long code sequence bits were intercepted, the whole long code sequence could be regenerated according to the Berlekamp-Massey algorithm [see James L. Massey, “Shift-Register Synthesis and BCH Decoding,” IEEE Trans. on Information Theory, 15:122-127, January 1969]. Once the long code sequence was recovered, the desired user's signal could be recovered through various signal separation and extraction algorithms, such as described in (1) S. Bhashyam and B. Aazhang, “Multiuser Channel Estimation and Tracking for Long-Code CDMA Systems,” IEEE Trans. on Communications, 50(7):1081-1090, July 2002; (2) C. J. Escudero, U. Mitra, and D. T. M. Slock, “A Toeplitz Displacement Method for Blind Multipath Estimation for Long Code DS/CDMA Signals,” IEEE Trans. on Signal Processing, 49(3):654-665, March 2001; and (3) Lang Tong, van der Veen A., P. Dewilde, and Youngchul Sung, “Blind Decorrelating RAKE Receivers for Long-Code WCDMA,” IEEE Trans. on Signal Processing, 51(6):1642-1655, June 2003.

An approach, called “secure scrambling”, is discussed above as the first embodiment, to enhance the physical layer built-in security of CDMA systems. Performance analysis demonstrated that while providing significantly improved information privacy, a CDMA system with secure scrambling has comparable computational complexity and system performance with that of the IS-95 system.

Note that after spreading and scrambling, chips spread from one symbol still cluster together, and could be fragile to severe fading effects or burst errors, in which the whole symbol may be lost. Interleaving is a widely used technique to randomize burst errors. Below, the relationship between interleaving and scrambling is discussed as is the use of chip-level interleaving to replace or supplement scrambling. As discussed further below, such use of interleaving improves the system performance in an environment with deep fading or strong burst errors while achieving the same security level as secure scrambling.

### VI. System Description of the Second Embodiment

A. Relationship between Scrambling and Interleaving

Interleaving is commonly used to obtain time diversity without adding any overhead. An interleaver π is a permutation i [symbol] π(i) that changes the time order of a data sequence of input symbols.

From a mathematical point of view, the process of chip-level interleaving in a CDMA system using BPSK modulation can be represented by:

$$\underline{S} \frac{π}{k} = {\underline{S}}_{k} \cdot {\underline{C}}_{k} , k = 1 , … , K \qquad ( 20 )$$

where Sₖ is the chip-level signal of user k before interleaving, Sₖ^{π} denotes the interleaved chip-level signal of user k and “.” represents element-wise production. Cₖ is a binary (±1) vector which can be taken as a special scrambling sequence. That is, interleaving is a special case of scrambling. However, scrambling is not necessarily a case of interleaving, because scrambled chip-level signals may not be de-permutated to the original chip-level signals by simply arranging the time order of the scrambled sequence in all possible ways.

If the interleaver is deep enough, the resulting Cₖ will be a random sequence, which can scramble the spread data sequence so that the interference caused by multiple access can be effectively suppressed. That is, the major functionality of a scrambling sequence can be maintained by a random interleaver.

The function of the interleaver is to randomize the successive information so that when there is a deep fade or burst noise, the successive data is not corrupted at the same time. Since the permuted chip-level signal results in the corrupted chips being uniformly distributed over several original bits, each bit only suffers a small portion of loss and can still be correctly recovered. Therefore, a chip-level interleaver can effectively combat deep channel fading with relatively long duration, such as more than half the symbol period, for which the scrambling process would otherwise most likely result in an error.

B. System Model

As is well known, the spreading codes of the operational IS-95 system are chosen to be Walsh codes, which are easy to generate, so the physical layer built-in security of CDMA systems mainly relies on the long pseudo-random scrambling sequence, but the built-in information privacy provided by scrambling sequence is far from adequate as discussed above and in Muxiang Zhang, Christopher Carroll, and Agnes Hui Chan, “Analysis of IS-95 CDMA Voice Privacy,” in Selected Areas in Cryptography, pages 1-13, 2000.

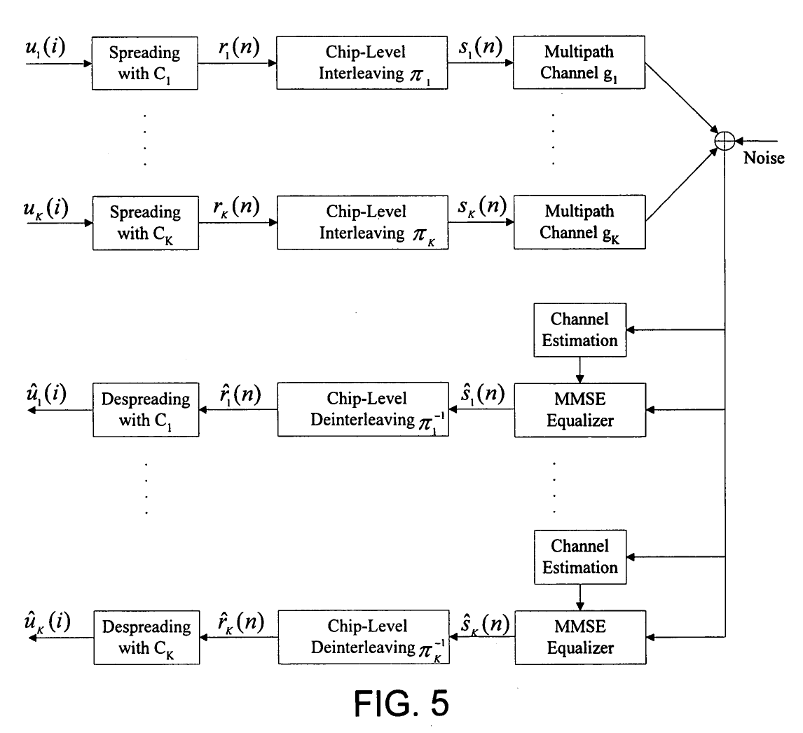

Since interleaving can randomize the spread data sequence so as to suppress the interference like scrambling, chip-level interleaving may be used as a substitution of scrambling or as a supplement to scrambling in this second embodiment of the present invention. Consider a DS-CDMA system with K users, as shown in FIG. 5. Assuming the processing gain is N, that is, there are N chips per symbol. Let uₖ(i) (k=1, . . . , K) denote user k's ith symbol of the user's symbol-level plaintext message signal. Without loss of generality, let
cₖ=[cₖ(0)cₖ(1) . . . cₖ(N−1)] (21)
denote user k's spreading code. The spread chip-level signal can be expressed as

$${r}_{k} ( n ) = {\sum }_{i = - ∞}^{∞} {u}_{k} ( i ) {c}_{k} ( n - iN ) . \qquad ( 22 )$$

The successive interleaving process is achieved by
sₖ(n)=πₖ(rₖ(n)), (23)
where πₖ represents a block interleaver with one-to-one mapping from rₖ(n) to sₖ(n).

Let {gₖ(l)}ₗ₌₀^{L-1} denote the kth user's (chip-rate) channel impulse response from the transmitter to the receiver, the received chip-rate signal can be expressed as

$$y ( n ) = {\sum }_{K - 1}^{K} {\sum }_{l = 0}^{L - 1} {g}_{k} ( l ) {s}_{k} ( n - 1 ) + w ( n ) . \qquad ( 24 )$$

where w(n) are samples of zero-mean complex Gaussian random process independent of the information sequences.

At the receiver end, the desired user's signals are extracted through a two-stage procedure. First, “separated training” (meaning the training sequence is chosen to be a Gold sequence and is not scrambled) based channel estimation is performed through a correlation method and an MMSE equalizer is applied to compensate for the disturbance induced by multipath propagation. Then, chip-level deinterleaving and despreading are sequentially carried out to recover the symbol-level signals.

Without knowledge of the spreading code or interleaver/deinterleaver, it is impossible to recover the desired user's signal. The physical layer built-in security of the inventive scheme now relies on the security of the interleaver/deinterleaver. The secure interleaver may be generated using an AES algorithm in order to prevent exhaustive key search attack. The proposed secure interleaver aims to provide strong security and significantly improve the system performance in an environment having severe channel fading or burst errors.

### VII. Security Enhancement thought Secure Block Interleaving

A. Secure Block Interleaving

The proposed secure block interleaving is easy to implement and can be summarized as the following three steps:
i) Perform conventional block interleaving of the chip-level signal at size M×N, where M, N are exponentials of 2, and MN≧L, where L is the length of the chip sequence. If L/N is not an integer, fill up the rest of the block interleaver with 0's.
ii) Calculate the row index vector, denoted by πₘ^{r}, using the AES algorithm for each individual row m, (m=1, 2, . . . , M). Similarly, calculate the column index vector, denoted by πₙ^{c}, using the AES algorithm for each individual column n, (n=1, 2, . . . , N).
iii) Perform row permutation πₘ^{r} for each row m followed by column permutation πₙ^{r} for each column n, then read out the contents of interleaver in column-wise fashion.

To illustrate the generation of a row index vector πₙ, a 128×128 block interleaver is used below as example. Each column index vector πₙ^{c} can be generated in the same manner. To generate a row index vector πₘ^{r}, the following steps may be performed.
1) Specify an arbitrary 128-bit plaintext and a 128-bit key. Encrypt the plaintext with the key using the AES algorithm, and the ciphertext is also 128 bits, denoted by {pc₀, pc₁, . . . , pc₁₂₇}.
2) Because the row index is from 1 to 128, each position can be represented by log₂(128)=7 bits. Form a 1×134 vector by cyclic padding, [pc₀pc₁, . . , pc₁₂₇pc₀pc₁, . . . pc₅]. Then divide it into 128 7-bit groups:

$$vector , ⌊ {pc}_{( i - 1 )} {pc}_{( i mod 128 )} ⋯ {pc}_{( i + 5 mod 128 )} ⌋ , i . e . , \\ \begin{matrix}P ( i ) = {pc}_{i - 1} \cdot {2}^{6} + {pc}_{( i mod 128 )} ) \cdot {2}^{5} + {pc}_{( i mod 128 )} \cdot {2}^{4} + \\ {pc}_{( i + 2 mod 128 )} \cdot {2}^{3} + {pc}_{( i + 3 mod 128 )} \cdot {2}^{2} + \\ {pc}_{i + 4 mod 128 )} \cdot {2}^{1} + {pc}_{( i + 5 mod 128 )} \cdot {2}^{0} + 1\end{matrix} \qquad ( 26 )$$
3) For i=1, 2, . . . , 128, P(i) denotes the decimal number corresponding to the ith 7-bit

$$[ {pc}_{0} {pc}_{1} ⋯ p {c}_{6} ] , [ {pc}_{1} {pc}_{2} ⋯ p {c}_{7} ] ⋯ , [ {pc}_{127} {pc}_{0} ⋯ p {c}_{5} ] \qquad ( 25 )$$
Define P=[P(1) P(2) . . . P(128)]. P does not necessarily contain all the numbers from 1 to 128 as there may be repeated numbers. The following operations are taken to replace all the repeated numbers with missing numbers:
   a) Stack all the missing numbers in P from [1, 2, 3, . . . , 128] into a vector A, A=[A(1) A(2) . . . A(M)].
   b) Find the index of each repeated number in P and stack them to formulate a vector B, B=[B(1) B(2) . . . B(M)]. Clearly the length of A is equal to that of B.
   c) Let P(B(i))=A(i), i.e., substitute A(i) for the B(i)'s entry in P.
The resulting vector contains all the numbers from 1 to 128, and each number occurs only once. This vector is exactly a row permutation, called “row interleaver”.

The rest of the 127 row interleavers and all the column interleavers may similarly be obtained.

At the receiver end, “secure block deinterleaving” is performed by anti-permuting. So both the transmitter and receiver should know the shared key and original plaintexts to generate the correct row index vectors and column index vectors.

B. Security Analysis of the Proposed Approach

In this subsection, the security of the proposed secure block interleaving, which is essentially ensured by the AES algorithm is evaluated. The number of possible keys of AES are compared with that of the conventional IS-95 scrambling sequence. Security measurement through the number of all possible keys is based on the assumption that the attacker has no easy access to the secret encryption key, therefore, the attacker has to perform an exhaustive key search in order to break the system. As is well known, the security of AES is based on the infeasible complexity in recovering the encryption key. Currently, no weakness has been detected for AES, thus, exhaustive key search is still being recognized as the most effective method in recovering the encryption key.

Listed in Table II below are the number of possible keys of IS-95 and the number of possible keys of the inventive system with secure block interleaving. IS-95 only has a 42-bit shared secret key, that is, the initial states of the linear feedback shift register (LFSR). The approximate number of keys for IS-95 is about 4.40×10¹². On the other hand, even if a 128-bit AES algorithm is chosen for secure block interleaving, the number of AES keys are on the order of 10²⁶ times more than that of IS-95. Assuming that one could try 2⁵⁵ keys per second (a very ambitious assumption and far from what we can do today), then it would take approximately 149 thousand-billion years to crack a 128-bit AES key, while it only takes 1×10⁻⁴ second to break the IS-95 long code generator.

TABLE II
SECURITY COMPARISON BETWEEN
IS-95 AND PROPOSED SCHEME

| | | |
|---|---|---|
| IS-95 | 42-bit LFSR | 4.4 × 10¹² possible keys |
| Secure | 128-bit AES | 3.4 × 10³⁸ possible keys |
| Block | 192-bit AES | 6.2 × 10⁵⁷ possible keys |
| Interleaving | 256-bit AES | 1.1 × 10⁷⁷ possible keys |

As discussed above with respect to the first embodiment, for the conventional IS-95 system, the entire scrambling sequence can be regenerated as long as 42 successive bits of the scrambling sequence are intercepted. For secure block interleaving, even if one row or column interleaver is intercepted, the attacker still needs to recover the secret key K in order to regenerate the entire secure block interleaver. Infeasible complexity in recovering the key ensures that the proposed scheme can significantly improve the physical layer built-in security of CDMA systems.

### VIII. Simulations

In this section, simulation examples are provided to demonstrate that while providing strong physical layer built-in security, secure block interleaving can improve system performance in an environment with deep fading or strong burst errors and has comparable computational complexity with that of the conventional scrambling and secure scrambling.

A. System Performance

We consider a CDMA system with eight users. The spreading codes are Walsh codes and the processing gain is N=16. The training sequence was chosen to be a Gold sequence of length 63, and no scrambling or interleaving process is applied to the training part. The block size of the information symbols for each user is 1024. Assume QPSK signals are transmitted over four-ray multipath channels for each user, with the first path being the dominant path. The multipath delays are uniformly distributed over the interval [0, N−1]. That is, the maximum multipath delay L was allowed to be up to one symbol period, a reasonable assumption for wideband CDMA systems. Multipath channels and information sequences were generated randomly in each Monte Carlo run. And the result was averaged over 100 runs. Without loss of generality, User 1 was chosen to be the desired user. SNR was defined as the chip SNR with respect to User 1.

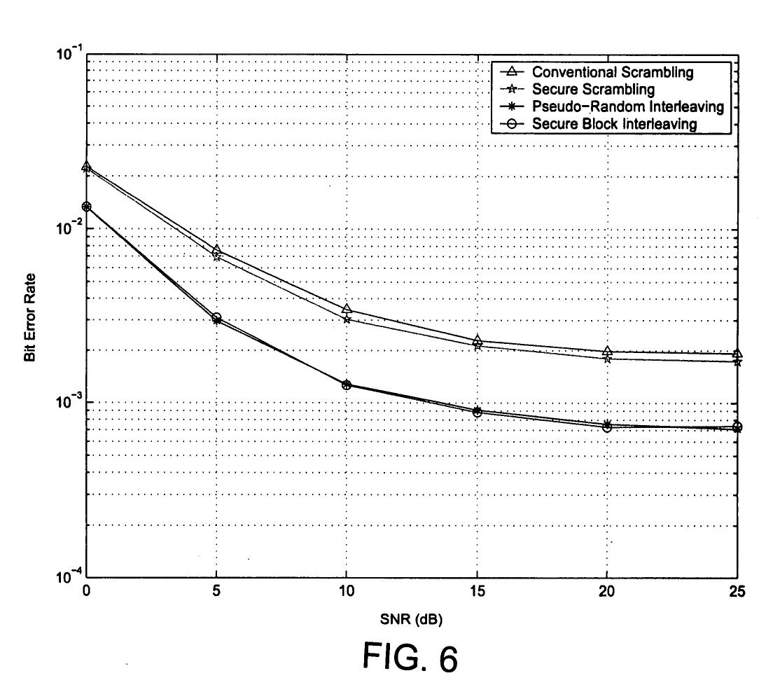

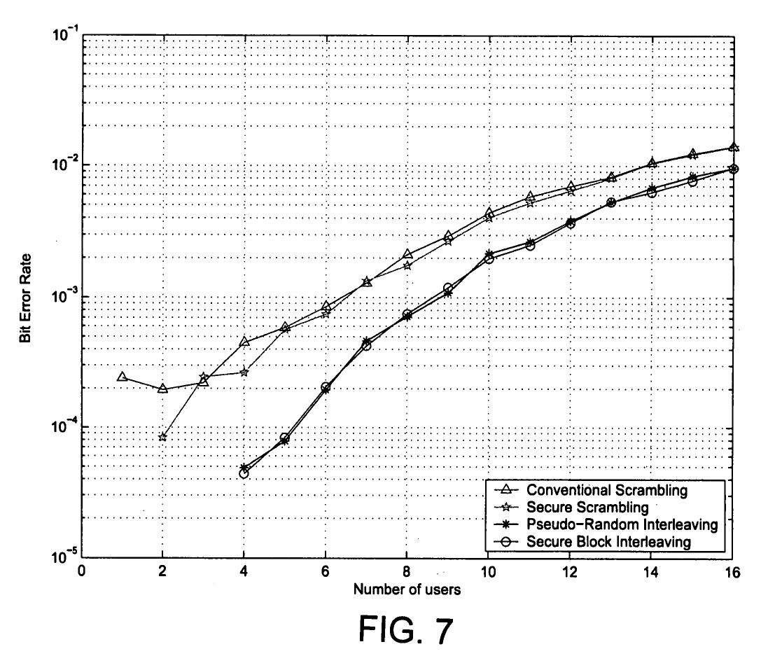

FIG. 6 and FIG. 7 show the comparison of system performance over channels with severe fading for four scenarios: conventional scrambling, secure scrambling, pseudo-random interleaving and secure block interleaving. Assume that channel impulse response remains invariant over ¼ block size and ¼ block size of the chip sequence undergoes a deep fade through the channel. Pilot symbols are inserted for every ¼ block to obtain accurate channel information. As can be seen, the inventive system using secure block interleaving has a significant improvement of performance over channels with severe fades.

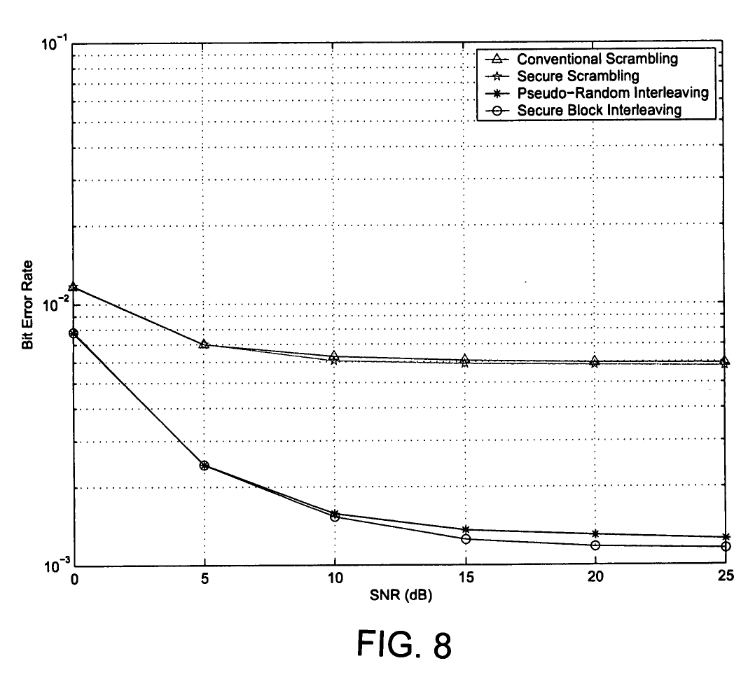

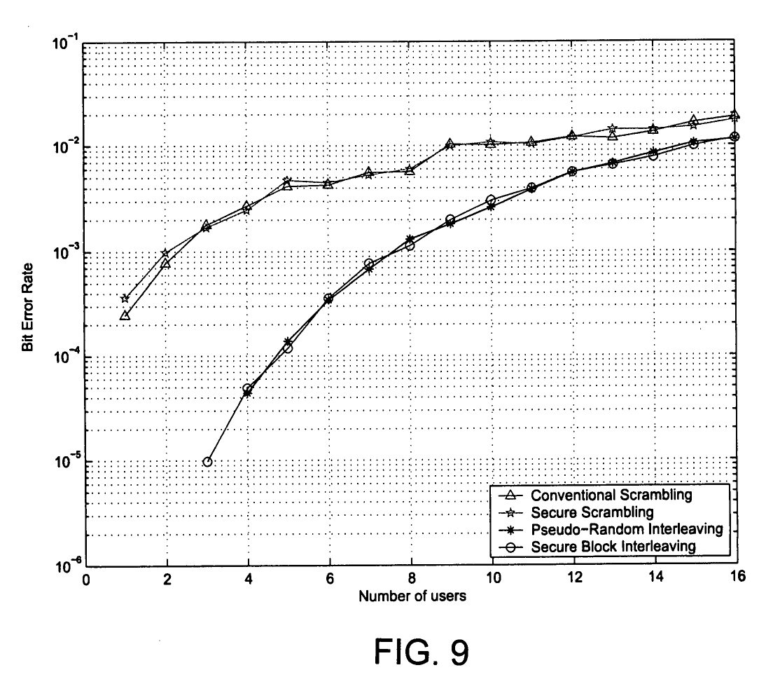

FIG. 8 and FIG. 9 correspond to the comparison of four scenarios when the channel has strong burst noise. Thirty-two noise bursts, each of which lasts one symbol period and has the same power level as that of the desired user's signal, were randomly generated and added to the randomly selected symbols. The simulation results thus confirm the advantages of using the interleaver.

B. Computational Complexity

In this subsection, we compare the computational complexity of the inventive secure block interleaving of the second embodiment, conventional scrambling, and the inventive secure scrambling of the first embodiment.

Using a Dell computer with 1024M RAM and 2.8 GHz CPU speed, the time required to perform (1) conventional scrambling, (2) the secure scrambling of the first embodiment, and (3) secure interleaving of the second embodiment. The results provided in Table III below thus compare the relative processing times for secure interleaving with conventional and secure scrambling of the same size data blocks. As shown, the time of AES encryption required in secure block interleaving is about twice as long as that of conventional scrambling. Thus, the computational complexity of secure interleaving is comparable with that of the other two methods.

TABLE III
COMPLEXITY COMPARISON OF THREE GENERATION METHODS

| Generation method | Time (seconds) |
|---|---|
| Conventional scrambling in IS-95 (128 bits) | 0.0226 |
| Secure scrambling (128 bits) | 0.0536 |
| Secure interleaving (a 1 × 128 index vector) | 0.0597 |

Compared with the first embodiment, which provides strong physical layer built-in security ensured by AES, as chips spread from each symbol are further randomized, the chip-level secure interleaving process of the second embodiment delivers much better system performance in channels with severe fading or burst errors.

The above description is considered that of the preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

What is claimed is:

1. A transmitter for use in a spread spectrum communication system, the transmitter comprising:
a spreading block for receiving a user's plaintext message and spreading the plaintext message to generate a chip-level signal;
a secure scrambler for scrambling and encrypting the chip-level signal using a long code sequence generated by the advanced encryption standard algorithm; and
a transmitter circuit for transmitting the securely scrambled chip-level signal.

2. The transmitter of claim 1, wherein the long code sequence is generated by the advanced encryption standard algorithm with a key which has at least 128 bits.

3. A receiver for use in a spread spectrum communication system, the receiver comprising:
a receiver circuit for receiving a securely scrambled chip-level signal;
a secure descrambler for descrambling the securely scrambled chip-level signal using a long code sequence generated by the advanced encryption standard algorithm; and
a despreading block for receiving the decrypted chip-level signal and despreading the chip-level signal to generate a sender's original plaintext message.

4. The receiver of claim 3, wherein the long code sequence is generated by the advanced encryption standard algorithm with a key which has at least 128 bits.

5. A method for enhancing the built-in security of a spread spectrum communication system, the method comprising the steps of:
receiving an originator's plaintext message and spreading the plaintext message to generate a chip-level signal;
securely scrambling the chip-level signal using a long code sequence generated by an advanced encryption standard algorithm; and
transmitting the securely scrambled chip-level signal.

6. The method of claim 5 further comprising the steps of:
receiving the scrambled and encrypted chip-level signal;
descrambling and decrypting the scrambled and encrypted chip-level signal using the long code sequence generated by the advanced encryption standard algorithm; and
despreading the chip-level signal to generate the originator's plaintext message.

7. The method of claim 5, wherein the long code sequence is generated by the advanced encryption standard algorithm with a key which has at least 128 bits.

8. A transmitter for use in a spread spectrum communication system, the transmitter comprising:
a spreading block for receiving a user's symbol-level plaintext message signal and spreading the plaintext message signal to generate a chip-level signal;
an interleaver operator for interleaving segments of the chip-level signal through a block interleaver; and
a transmitter circuit for efficient transmission of the interleaved segments of the chip-level signal.

9. The transmitter of claim 8, wherein the interleaver is generated using the advanced encryption standard algorithm.

10. The transmitter of claim 8, wherein the interleaver operator arranges the segments of the chip-level signal in a two dimensional matrix and wherein the block interleaver includes at least one row interleaver for the rows of the matrix and at least one column interleaver for the columns of the matrix.

11. The transmitter of claim 10, wherein each of the interleavers is generated using the advanced encryption standard algorithm.

12. The transmitter of claim 8, wherein the interleaver operator arranges the segments of the chip-level signal in a two dimensional matrix and wherein the block interleaver includes a row interleaver for each row of the matrix.

13. The transmitter of claim 12, wherein said interleaver operator interleaves the segments of the chip-level signal by performing a permutation for each row of the matrix using a corresponding row interleaver.

14. The transmitter of claim 12, wherein the block interleaver further includes a column interleaver for each column of the matrix.

15. The transmitter of claim 14, wherein said interleaver operator interleaves the segments of the chip-level signal by further performing a permutation for each column of the matrix using a corresponding column interleaver.

16. The transmitter of claim 8, wherein the plaintext message is a data message.

17. The transmitter of claim 8, wherein the plaintext message is a voice message.

18. The transmitter of claim 8, wherein said spreading block converts the symbol-level plaintext message signal to the chip-level signal by multiplying each input symbol of the plaintext message signal with a user-specific channelization code vector.

19. The transmitter of claim 8 and further comprising a scrambler for receiving and scrambling the chip-level signal received from said spreading block using a long code sequence.

20. A receiver for use in a spread spectrum communication system, the receiver comprising:
a receiver circuit for receiving a signal including interleaved segments of a chip-level signal;
a deinterleaver operator for deinterleaving the interleaved segments of the chip-level signal using a block interleaver to output a chip-level signal; and
a despreading block for receiving the chip-level signal and despreading the chip-level signal to generate a sender's original plaintext message signal.

21. The receiver of claim 20, wherein said receiver circuit comprises a channel estimator and an MMSE equalizer.

22. The receiver of claim 20, wherein the block interleaver is generated using the advanced encryption standard algorithm.

23. A method for enhancing security of a spread spectrum communication system, the method comprising the steps of:
receiving an originator's symbol-level plaintext message signal and spreading the plaintext message signal to generate a chip-level signal;
interleaving segments of the chip-level signal through a secure block interleaver; and
transmitting the interleaved segments of the chip-level signal.

24. The method of claim 23 further comprising the steps of:
receiving the transmitted interleaved segments of the chip-level signal;
deinterleaving the interleaved segments of the chip-level signal through the secure block interleaver to output the chip-level signal; and
despreading the the chip-level signal to generate the originator's plaintext message signal.

25. The method of claim 23, wherein the block interleaver is generated using the advanced encryption standard algorithm.

26. The method of claim 23, wherein the step of interleaving includes the step of arranging the segments of the chip-level signal in a two dimensional matrix, wherein the block interleaver includes a row interleaver for each row of the matrix.

27. The method of claim 26, wherein the step of interleaving includes the step of performing a permutation for each row of the matrix using a corresponding row interleaver.

28. The method of claim 26, wherein the block interleaver further includes a column interleaver for each column of the matrix.

29. The method of claim 28, wherein the step of interleaving includes the step of performing a permutation for each column of the matrix using a corresponding column interleaver.

30. The method of claim 28, wherein each of said interleavers are generated using the advanced encryption standard algorithm.
